(19) United States
(12) Patent Application Publication
(10) Pub. No.: US 2019/0303622 A1
(43) Pub. Date: Oct. 3, 2019

(54) BICAMERAL FRAMEWORK FOR FAST AND TAMPER-RESISTANT BLOCKCHAIN VALIDATION

(71) Applicant: CA, Inc., New York, NY (US)

(72) Inventors: Steven Cornelis VERSTEEG, Ivanhoe (AU); John Sinclair BIRD, Ringwood (AU); Deborah Anne VETHECAN, Bulleen (AU)

(73) Assignee: CA, Inc.

(21) Appl. No.: 15/937,989

(22) Filed: Mar. 28, 2018

(51) Int. Cl. G06F 21/64

(52) U.S. Cl. CPC G06F 21/64

(57) ABSTRACT

A method includes obtaining a plurality of proof-of-stake blocks that include user data to be added to a blockchain database, and each of the proof-of-stake blocks is confirmed. In response to confirming each of the proof-of-stake blocks, each of the proof-of-stake blocks is added to the blockchain database. The method further includes obtaining a proof-of-work block that includes a representation of each of the proof-of-stake blocks added to the blockchain database and confirming the proof-of-work block. In response to confirming the proof-of-work block, the method adds the proof-of-work block to the blockchain database.

### BACKGROUND

This present disclosure relates to blockchain technology, including the validation systems and functions that administer blockchain databases, and more specifically to a bicameral framework for fast and tamper-resistant blockchain validation.

### BRIEF SUMMARY

According to an aspect of the present disclosure, a method includes obtaining a plurality of proof-of-stake blocks that include user data to be added to a blockchain database, and each of the proof-of-stake blocks is confirmed. In response to confirming each of the proof-of-stake blocks, each of the proof-of-stake blocks is added to the blockchain database. The method further includes obtaining a proof-of-work block that includes a representation of each of the proof-of-stake blocks added to the blockchain database and confirming the proof-of-work block. In response to confirming the proof-of-work block, the method adds the proof-of-work block to the blockchain database.

Other features and advantages will be apparent to persons of ordinary skill in the art from the following detailed description and the accompanying drawings.

### BRIEF DESCRIPTION OF THE DRAWINGS

FIG. 1 illustrates a network of distributed nodes.

FIG. 2 illustrates an embodiment of proof-of-work and proof-of-stake blocks of a blockchain database.

FIG. 3 illustrates an alternative embodiment of proof-of-work and proof-of-stake blocks of the blockchain database of FIG. 2.

FIG. 4 illustrates an alternative embodiment of proof-of-work and proof-of-stake blocks of the blockchain database of FIG. 2.

FIG. 5 illustrates an embodiment of proof-of-stake blocks added to the blockchain database illustrated in FIG. 4.

FIG. 6 illustrates an embodiment of proof-of-work block added to the blockchain database illustrated in FIG. 5.

FIG. 7 illustrates a generalized view of a blockchain database including proof-of-stake blocks and proof-of-work blocks.

### DETAILED DESCRIPTION

One skilled in the art appreciates that aspects of the present disclosure may be illustrated and described as pertaining to several patentable classes or contexts, including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

The aspects of the present disclosure may use one or more computer readable media. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. Unless specifically indicated otherwise, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

This disclosure includes flowchart illustrations and/or block diagrams of methods, apparatuses (e.g., systems or computers), and computer program products according to embodiments of the disclosure to reference aspects of the present disclosure. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks, or otherwise described herein.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While embodiments of the present disclosure may be described with respect to financial transactions or cryptographic currencies, or other industry, one of ordinary skill in the art appreciates that the embodiments disclosed herein are useful in other industry, context, and applications. Specifically, the methods, computers, and systems described herein are not limited to blockchain based cryptographic currencies, and one of skill in the art will appreciate that broader applications fall within the scope of the present disclosure.

Blockchain technology refers generally to a technique for storing information. In other words, a blockchain is a type of database. Rather than storing the database in a single central location, blockchain refers distributed databases, which may be maintained and managed by peer-to-peer networks comprised of many nodes, wherein the nodes maintain the blockchain according to an agreed protocol. Blockchain technology is not limited to peer-to-peer networks, and several applications to private networks are emerging.

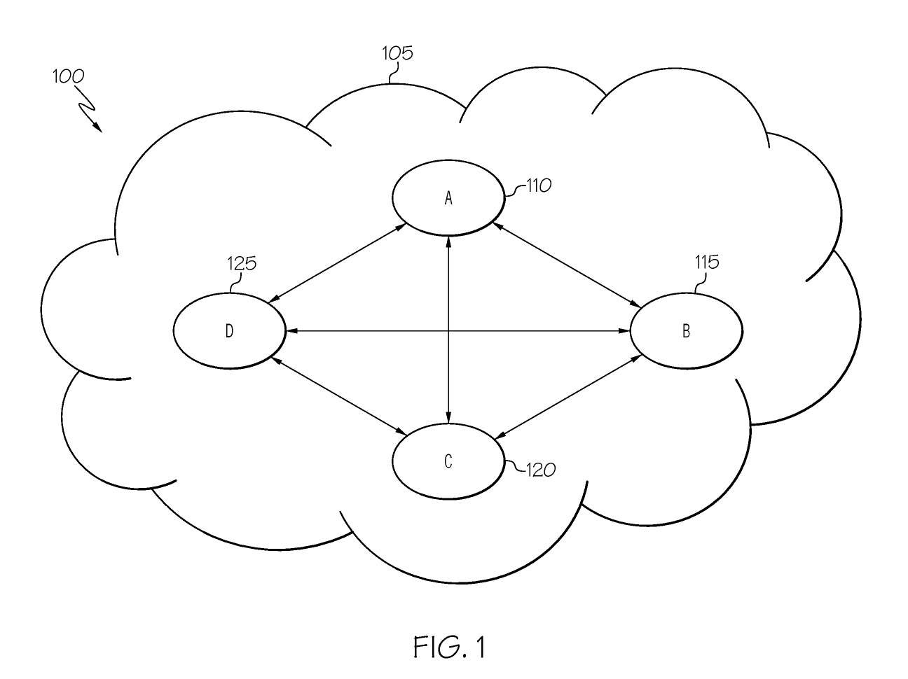

A network of distributed nodes 100 is illustrated in FIG. 1. FIG. 1 illustrates four nodes, node A 110, node B 115, node C 120, and node D 125; however, embodiments of the present disclosure may include fewer or more than four nodes. In addition, network 105 may be the Internet. Network 105 may be a Bluetooth™ network, a Wifi network, cellular network, local area network, wide area network, storage area network, virtual private network, personal area network, or other type of network. Thus, network 105 may be a wired or wireless network or, in certain embodiments, may be wired and wireless.

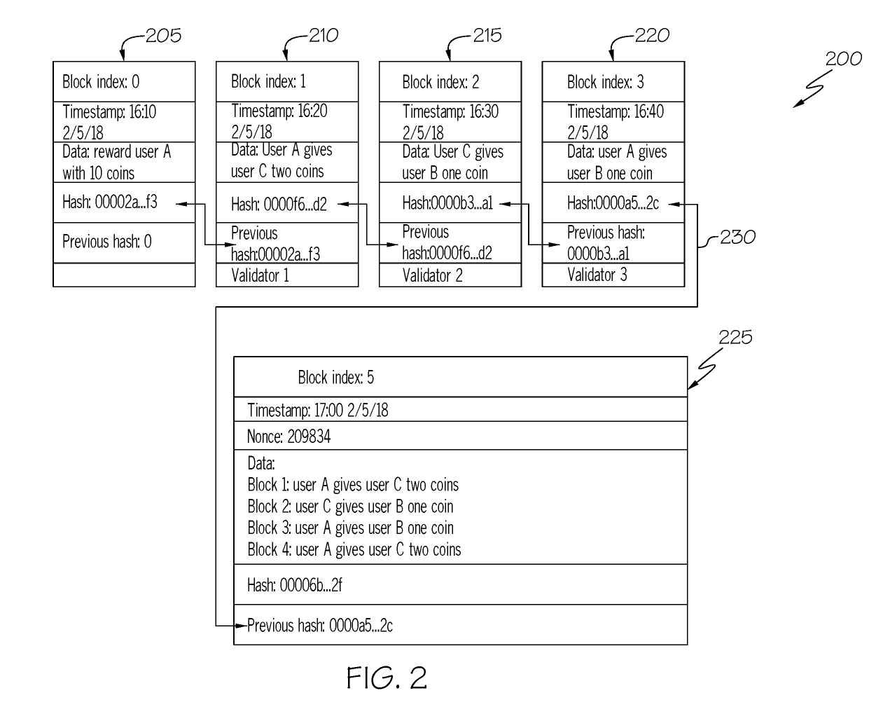

A blockchain database, such as that illustrated in FIG. 2, may include one or more blocks. For example, the segment of blockchain database 200 illustrated in FIG. 2 includes five blocks (205, 210, 215, 220, and 225). The blockchain refers generally to a data structure or database for storing the blocks. For example, the blocks may be stored using an array data structure, or more simply, an array. Arrays, as one of ordinary skill in the art would appreciate, refer generally to a collection of elements. One of skill in the art would recognize other techniques for storing and accessing a collection of data elements. For example, blockchains may be implemented using data structures other than the array, such as lists including linked lists, and other tree-based data structures. Block structures may be linked expressly or inherently. For example, blocks may be linked via pointers, including linkage by hash pointer to other blocks of the blockchain data structure, such as hash pointer link 230.

Blockchains may be used to store or record varying types of data. Blockchain technology can be used to store and record a ledger of transactions, contractual obligations, sensitive data, time-based data, file systems, decentralized cloud file storage, for example. FIG. 2, for example, illustrates user data comprising financial transactions. Storing data in the blockchain itself is one solution, however, an alternative is to store representations of the data in the blockchain and use the blockchain to test the veracity and integrity of data stored elsewhere. In this way, the blockchain may store immutable fingerprints of data, rather than the actual data. The blockchain may include a genesis block, such as genesis block 205 illustrated in FIG. 2. The genesis block may be a hardcoded block that anchors the blockchain. The genesis block may or may not contain block data.

Blocks may be data structures. In some embodiments, a block comprises an n-tuple set of data values. As illustrated in FIG. 2, block 210 may include, for example, an index value, a timestamp, block data, a hash value of the block itself, and a hash value of the previous block in the blockchain. Block 210, which in some embodiments may be a proof-of-stake block, also includes validator information of a proof-of-stake validator. Block 225, which in some embodiments may be a proof-of-work block, may include a nonce or salt value as proof-of-work. As FIG. 2 illustrates, a chain of blocks, linked together through hash pointers, such as hash pointer 230, is created by including in each block the hash value of the block before it. Chaining, or use of the overlapping hashes, is a fundamental aspect of the system and functions that protect the integrity of the blockchain. Even the slightest change or modification of data stored in a block may result in an unpredictable and significant change in the block's hash value. Discrepancies with the block's hash value propagate down the chain, due to the overlapping hash values chaining each block to one other.

By including the hash value of the block in each block, blocks can be verified and tampering easily detected by applying the cryptographic hashing algorithm to the block to obtain the block's hash value and comparing the determined hash value with the hash value recorded as part of the block. Cryptographic hash functions take an input and return a fixed size value or string. The output value from the hash function may be referred to as a hash value, message digest, digital fingerprint, digest, or checksum. Cryptographic hash functions preferably make it easy to calculate a hash value for any data input, make it computationally difficult to calculate the data input given the hash, and make it extremely unlikely that two nearly-identical but slightly different inputs have the same hash. An example of a cryptographic hash function is the SHA-256, and several others are known in the art. Thus, if the transactions in the block are tampered with after creation and setting the hash value, the hash value of the tampered block will not be the same as the original block, and a discrepancy will exist between the block's hash value and its recorded hash value. This discrepancy may result in nodes rejecting the chain containing the fraudulent block.

The protocols and architecture of the blockchain provide protection against tampering with the data stored via the blockchain. One such mechanism is known as consensus or distributed consensus. In the context of blockchains, consensus may refer to a node's decision of whether to add block or specific transaction to the blockchain. Consensus in blockchains may be distributed, meaning that several participants of the peer-to-peer network participate in the consensus mechanism. Consensus often serves at least two purposes: ensuring that the next block in the blockchain or the data being proposed to be added to the blockchain is the singular version of the truth, and it deters and prevents adversaries from compromising the network.

Blockchains use various protocols for achieving distributed consensus that protect the integrity of the blockchain data. Two of those techniques are known as proof-of-work and proof-of-stake. While each technique involves a means for achieving distributed consensus, their architecture and operation are very different.

In proof-of-work mechanism, “miner” nodes compete against one another to add the next block, which contains some data, to the blockchain. The miners are competing to find a valid answer to a cryptographic puzzle. With proof-of-work, the first node to solve a puzzle wins a mining reward as compensation for the work spent mining. Mining blocks using a proof-of-work function is time and resource intensive. For example, in the Bitcoin blockchain, miners must produce a proof-of-work for every block by solving complex cryptographic target hash puzzles. Transactions, i.e., block data, only becomes confirmed and verified when written into a block on the blockchain. The security of block data depends on how many blocks have been written after it on the blockchain. The deeper a block of block data is buried, the more secure that data is against fraudulent activity or tampering. To explain further, using the Bitcoin proof-of-work mechanism, it takes roughly ten minutes of CPU power to solve each target hash puzzle, and thus a block is created roughly every ten minutes. The ten-minute delay is intentional in the Bitcoin blockchain architecture. The system is designed such that the difficulty of the puzzles automatically adjusts and self-corrects at predetermined periods of time to keep the probability of solving the puzzles low enough such that it takes roughly ten minutes to find the proof-of-work required for each and every block, no matter the amount of processing power one possesses or expends. Therefore, one drawback of proof-of-work functions, such as that in the Bitcoin blockchain architecture, is lack of speed in confirming transactions or other block data and adding it to the blockchain.

Proof-of-stake is an alternative to proof-of-work. Instead of requiring expensive computer equipment and real energy consumption to create a valid block, a “validator” or “stakeholder” (different nomenclature from proof-of-work “miners”) approves transactions based on their stake in the system. The concept of “stake” refers in certain embodiments to ownership. Proof-of-stake confirms transactions and creates blocks faster than proof-of-work. But, the increased speed comes at a price. Rather than solve difficult cryptographic puzzles, proof-of-stake relies on investment or ownership in the network to create blocks. That is, a node or user in a proof-of-stake system can mine or validate blocks according to how much value or worth he or she holds or owns. In the context of cryptographic currencies, for example, this means that the more coins a miner holds, the more mining power he or she has.

One can see then that proof-of-stake systems leverage concepts of mutually-assured-destruction—a fraudster attempting to tamper with the blockchain and destroy trust in the blockchain would have to own a majority or large share of the assets or wealth administered by that blockchain, for example, the majority of the coins in a cryptographic currency system. Thus, an attacker would suffer severely from their own attack. Instead of consuming electricity to power computers to solve tough cryptographic puzzles, as the proof-of-work system may, a proof-of-stake validator is limited to mining in proportion to their wealth. For example, a validator who owns 1% of the coin can, in theory, only mine 1% of the blocks. In some proof-of-stake functions, the network selects a node or participant to approve or validate the addition of new data and new blocks to the blockchain based on their proportional stake in the system. The selection of the validator in proof-of-work systems may be random selection, and participants are entered into the pool of candidates in direct proportion to their total stake in the network. Thus, the more stake one has, the higher the likelihood of being the selected validator. Using cryptographic currency for example, a stakeholder with 500 coins will be five times as likely to be chosen as the validator of a block than a stakeholder with 100 coins.

A scenario involving what is referred to as a 51% attack provides an illustration contrasting proof-of-work to proof-of-stake. A 51% attack is when a miner, or group of miners, controls 51% of the power to create blocks and creates fraudulent blocks for himself and is eventually able to take over the blockchain by creating fraudulent blocks faster than the honest validators or miners on the network. Because blockchain protocols often enforce what is known as the “longest chain rule,” the dishonest miner or node who is able to write blocks faster than the honest remainder of the network will eventually be able to create a chain that is longer than the honest chain, and nodes on the network will accept the longer, dishonest chain because of the longest-chain-rule built into the core protocol.

In a proof-of-work system, a dishonest miner or group of miners must attain 51% of the computational power of the network in order to theoretically be able to mine 51% of the blocks, because computational power is required to be expended to produce the proof-of-work. If the dishonest miners can mine the majority of the blocks, eventually they will be able to take over the network by creating the longest chain. In a proof-of-stake system, a dishonest miner or group of miners must attain 51% of the wealth in the network to theoretically be able to mine 51% of the blocks, because mining power is correlated to wealth in a proof-of-stake system. Notwithstanding the difficulty of obtaining 51% of the wealth, i.e., 51% of the coins, the holder of 51% of the wealth would be hurt by attacking the network in which he or she holds the majority stake in a proof-of-stake system.

Unlike proof-of-work functions in blockchain networks like Bitcoin, which take roughly ten minutes to solve, proof-of-stake validation can occur quickly and thus data can added to the blockchain quickly. However, proof-of-stake blockchains suffer from the “nothing-at-stake” problem—a participant with nothing to lose has no reason to behave benevolently. To address this problem, some networks require a pledge or bond from a validator, and if the validator acts badly, the pledged coins or bond may be forfeited.

Another consensus mechanism called proof-of-activity refers to a consensus mechanism that combines some concepts of proof-of-work and proof-of-stake. In proof-of-activity, the consensus protocol first requires proof-of-work miners to race to solve a cryptographic puzzle and find the next block, and upon finding a solution, the consensus protocol switches to proof-of-stake where a group of validators are chosen to validate or sign-off on the new block. Thus, every block requires proof-of-work consensus and proof-of-stake consensus before the next block can be written to the blockchain. That means that each block must be mined by proof-of-work miners and validated by proof-of-stake validators before it is added to the chain and before the next block can be added to the blockchain. Moreover, while proof-of-activity adds another layer of protection to the consensus protocol, it does not resolve the issue with the amount of time it takes to confirm transactions to the blockchain through proof-of-work.

Many blockchains rely predominantly on proof-of-work functions as the means of securing the network. However, despite its ability to achieve greater immutability and security, pure proof-of-work blockchains may be problematic for practical reasons. The foundation of proof-of-work is expenditure of copious amounts of computational power and are thus energy intensive and are not environmentally or economically viable as the network grows larger. Thus, pure proof-of-work blockchains may face difficulties scaling. In BitCoin, for example, where blocks are limited to one megabyte in size, the theoretical maximum capacity is around seven transactions per second. Whereas established payment networks are able to process tens of thousands of transactions per second. Embodiments of the present disclosure provide a blockchain architecture that achieves superior scalability than traditional proof-of-work blockchains.

Proof-of-stake blockchains, such as Hyperledger, for example, can achieve higher throughput than proof-of-work blockchains, but proof-of-stake blockchains may have inferior immutability characteristics compared to their proof-of-work blockchain alternatives. In proof-of-stake, an attacker controlling the majority of the network resources can not only control which new transactions or data gets written in a block to the blockchain, the attacker may also rewrite which transactions appeared in previous blocks, in other words, to rewrite history. In proof-of-work blockchains, even if an attacker temporarily has majority control of computing resources, the attacker or fraudster cannot rewrite history of previously written blocks without repeating the proof-of-work. This feature of proof-of-work thus provides heightened immutability.

The cumulative effect of some hybrid proof-of-stake and proof-of-work blockchain validation functions such as proof-of-activity is that only the security of the network is enhanced. The scalability and efficiency of the network, however, remain unchanged from the original proof-of-work design or, in some designs, the scalability and efficiency are degraded by the enhanced security. Specifically, with requiring each new block to be both validated through proof-of-stake and proof-of-work, or requiring chains that alternate proof-of-work and proof-of-stake in regular one-to-one ratio, the problem exists that adding data to the blockchain is held up and controlled by the proof-of-work function.

The bicameral architecture described in the present disclosure, however, improves scalability of the blockchain network because blocks can be validated and added to the blockchain with high speed (as a result of proof-of-stake consensus mechanism) due to the lack of resource intensity required to confirm transactions. Security is then bolstered through proof-of-work mechanism, which may operate concurrently with the proof-of-stake mechanism, and occurs whenever proof-of-work miners produce a proof-of-work, thereby finding a block to accommodate for the transactions approved by the proof-of-stake validators. Thus, by maintaining network security while simultaneously allowing for high speed transaction and high speed performance, the bicameral framework described herein is capable of delivering a higher performing solution.

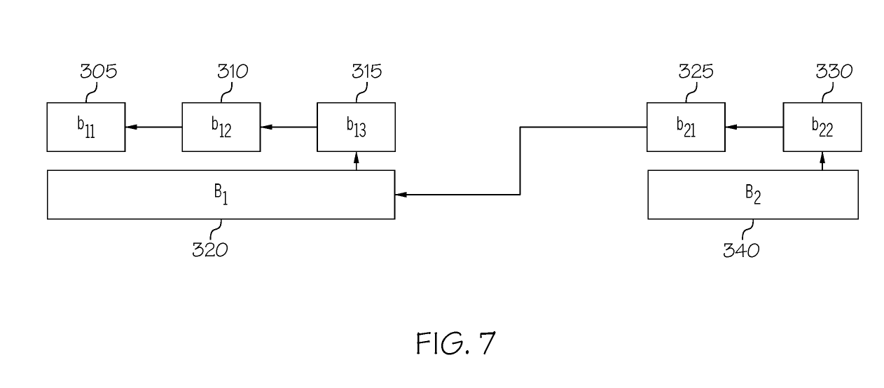

The technology described herein discloses a blockchain architecture that combines the high-throughput advantages of proof-of-stake with the high immutability advantages of proof-of-work. The present disclosure discusses a blockchain architecture and protocol utilizing proof-of-stake techniques to write microblocks of data to the blockchain on which megablock checkpoints created by proof-of-work miners are added. Thus, in some embodiments, such as that illustrated in FIG. 2, the consensus protocol is both proof-of-stake and proof-of-work, and some blocks are mined or validated via proof-of-stake functions (microblocks 205, 210, 215, and 220), and some are mined via proof-of-work functions (megablock 225), thereby creating a hybrid or combination proof-of-stake and proof-of-work blockchain. FIG. 7 also provides a generalized model of the hybrid chain.

In some embodiments, the consensus protocol herein described provides a bicameral framework using proof-of-stake and proof-of-work mechanisms in cooperation. The blockchain architecture described herein may be designed such that transactions can be confirmed and added to the blockchain, thereby increasing the chain, as soon as they have been validated by proof-of-stake validators and published across the network. In such embodiments, proof-of-stake validators will collect transactions and/or data into microblocks to be validated using proof-of-stake mechanisms. Validators will continue to collect data and transactions and publish proof-of-stake blocks to the blockchain. Meanwhile, megablocks containing the microblocks are mined using proof-of-work function. Thus, the protocol described herein may be described as bicameral, or dual-stage or dual-level. In the first level, proof-of-stake validators confirm transactions in microblocks. In the second level, proof-of-work miners continue mining until they find a solution to a current cryptographic puzzle and, once found, the miners will add a megablock representing microblocks to the blockchain. The megablocks may contain all the transactions of the microblocks already confirmed by proof-of-stake validators. The dual-stage or bicameral aspects does not mean a set alternating pattern of proof-of-stake block then proof-of-work blocks. Rather, these two functions may operate simultaneously in the disclosed bicameral blockchain architecture.

In certain embodiments, the blockchain protocol discussed herein operates by validating transactions in microblocks. The microblocks are written to the blockchain. Within the scope of the present disclosure, microblocks may refer to any block written to the blockchain as a result of proof-of-stake validators confirming the transactions within the microblock. That is, in some embodiments, microblocks containing user data are written first to the blockchain. In some embodiments, microblocks may be small-scale compared to megablocks, meaning that they contain much less data than a megablock. Each new microblock found subsequently from a genesis block may contain the hash value of the previous microblock, or as described below, the hash value of a mega block if the immediately preceding block in the chain is a proof-of-work megablock.

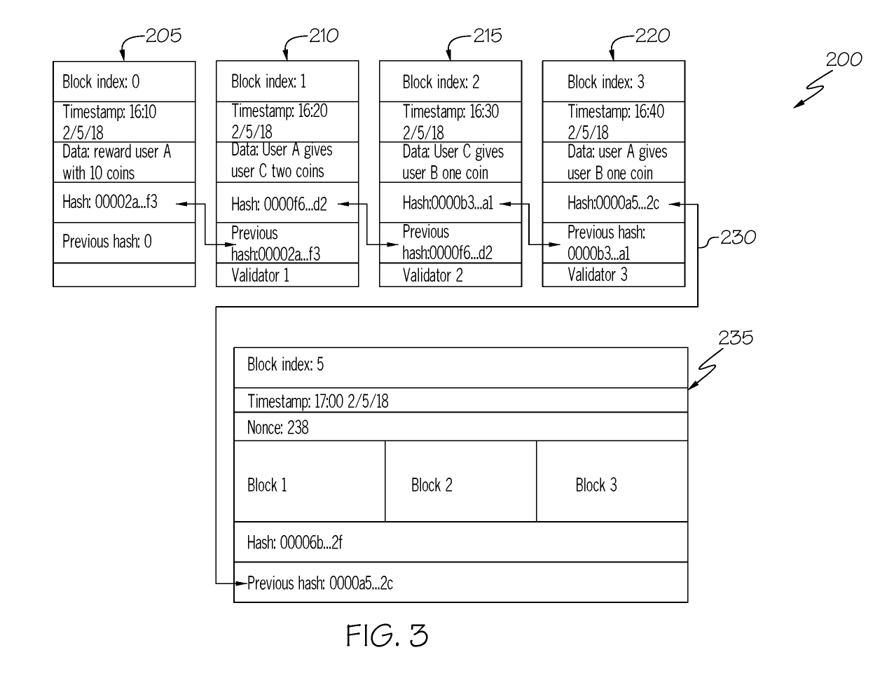

Within the scope of the present disclosure, megablocks may refer to any block added to the blockchain as the result of proof-of-work miners solving cryptographic puzzles and finding the block that contains the transactions of all previous microblocks up until the last megablock. In certain embodiments, megablocks mined by proof-of-work miners may contain all the transactions of the microblocks already confirmed by proof-of-stake validators up to the last megablock on the blockchain or the genesis block, depending on the maturity of the chain. For example, FIG. 3 illustrates proof-of-work megablock 235 including block data representing each of proof-of-stake microblocks 210, 215, and 220. In other embodiments, proof-of-work megablocks being mined may include the raw microblocks, the transactions in the microblocks, or the hash values of each of the microblocks represented. For example, proof-of-work block 235 in FIG. 3 illustrates representations of the proof-of-stake microblocks as the block data, and Block 225 in FIG. 2 illustrates the block data of the proof-of-stake microblocks as the megablock block data. In yet other embodiments, empty proof-of-work blocks may be mined and then populated with microblocks or proof-of-stake blocks once a proof-of-work solution is found. A megablock may then be created upon solving the current cryptographic puzzle, and the megablock may contain the hash value of the last microblock in the chain.

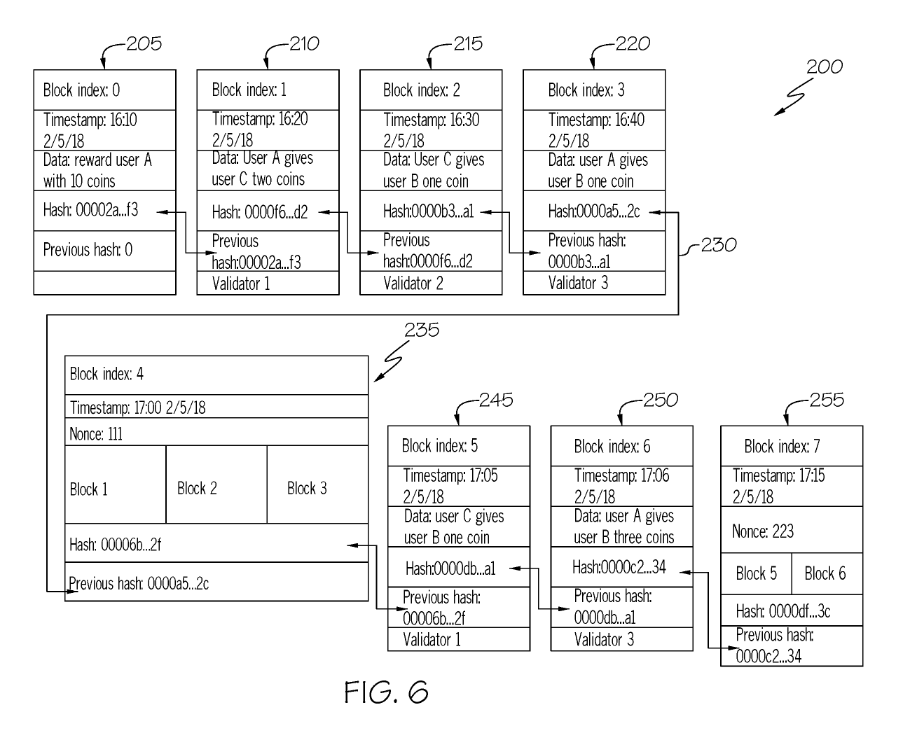

Thus, megablocks may include varying numbers of microblocks. Referring to FIG. 6, for example, proof-of-work megablock 235 represents three proof-of-stake microblocks 210, 215, and 220, and proof-of-work megablock 255 represents two proof-of-stake microblocks 245 and 250. In some embodiments, the megablock may comprise each microblock in the chain up to the previous megablock. In other embodiments, the megablock may comprise each transaction or a representation of each transaction in each microblock in the chain up to the previous megablock. Megablocks may vary in size and may encompass or include all the transactions contained in the microblocks up until the most recent megablock. Thus, one megablock may correspond to varying numbers of smaller microblocks, as illustrated in FIG. 3, FIG. 6, and FIG. 7.

Furthermore, the quantity of proof-of-stake and proof-of-work blocks in the blockchain architecture described herein may not be even and, in many embodiments, the majority of the blocks on the blockchain will be proof-of-stake blocks, which are less frequently confirmed via proof-of-work blocks being written to the blockchain. In this way, the architecture described herein may refer to a proof-of-stake blockchain architecture with a second level of confirmation and validation provided by a concurrent proof-of-work function that does not impede or slow down the processing and validation time for transactions and adding them to the blockchain. Thus, in the current architecture, the size of the proof-of-stake and proof-of-work blocks may vary and may not alternate at regular intervals. In this way, transactions may be added to the blockchain faster through proof-of-stake validators, and then subsequently confirmed via a proof-of-work megablock. Thus, blocks may be added to the chain prior to validation under both the proof-of-stake and proof-of-work functions, which provides a solution to the delay inherently introduced by proof-of-work functions, while ultimately providing the same level of security by using proof-of-work miners to validate groups of proof-of-stake microblocks.

Using the embodiment illustrated in FIG. 72 as an example, microblocks b₁₁, b₁₂, and b₁₃ (numerals 305, 310, and 315) may represent and each comprise one or more transactions or other data that is written to the blockchain via a proof-of-stake validator confirming the transactions and writing the block. As explained herein, the microblocks may be chained, meaning that the hash value of microblock b₁₁ may be included and referenced in microblock b₁₂, and the hash value of microblock b₁₂ may be included and referenced in microblock b₁₃, thereby expressly linking microblocks b₁₁ to b₁₃. In some embodiments the hash chain may refer to a chain of hash pointers. However, as illustrated in FIG. 7, the blockchains within the scope of the present disclosure may not maintain separate proof-of-stake and proof-of-work chains, but instead, may form a hybrid chain, wherein proof-of-stake and proof-of-work blocks populate the blockchain in cooperative agreement. For example, the embodiment in FIG. 7 does not directly chain microblock b₁₃ to the next microblock b₂₁. Instead, the embodiment illustrated in FIG. 7 shows that microblocks b₁₁, b₁₂, and b₁₃ may be linked to the next group of microblocks through intermediate megablock, B₁ (numeral 320). That is, megablock B₁ may represent each of microblocks b₁₁, b₁₂, and b₁₃, and be linked into the blockchain by including the hash value of microblock b₁₃, and the hash value of megablock B₁ may be included and represented in the next microblock b₂₁ (numeral 325), thereby forming the hybrid proof-of-stake and proof-of-work blockchain according to the methods and systems of the present disclosure.

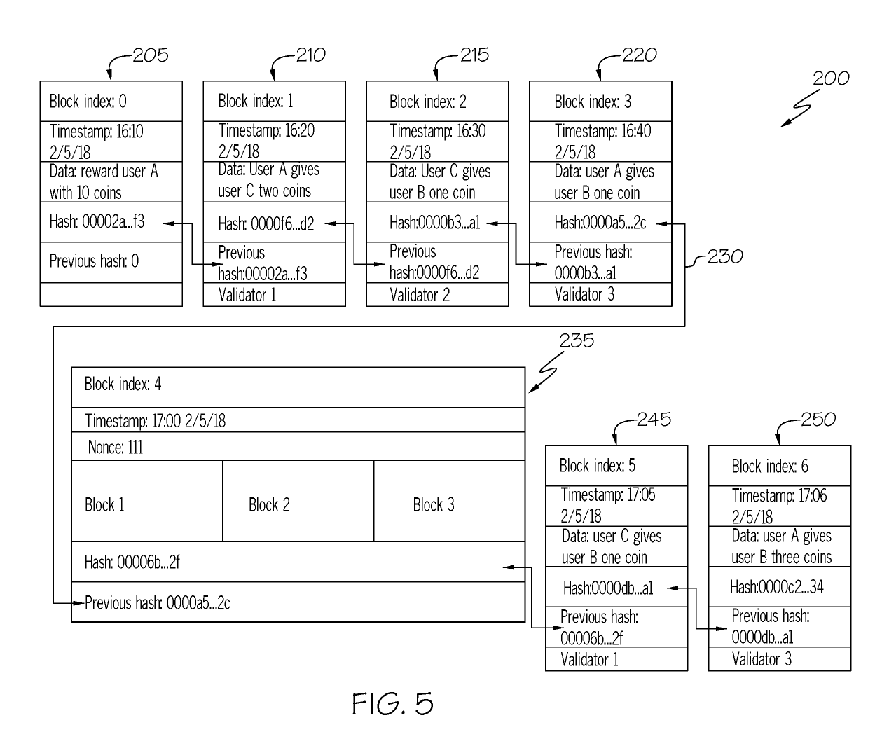

As FIG. 5 further illustrates, the next microblock 245 created subsequent to a megablock 235 may contain the hash of the most-recent megablock 235 in the chain. Therefore, the express linkage of the blockchain architecture described herein may comprise a hybrid linkage of proof-of-stake blocks and proof-of-work blocks. In this way, efficiency of the blockchain is increased as proof-of-stake validators continuously confirm transactions in microblocks while slower proof-of-work miners solve cryptographic puzzles to create megablocks, thereby confirming and securing the transactions contained in the microblocks with a proof-of-work.

In general, growing a blockchain through proof-of-stake functions is exceedingly faster than proof-of-work blockchain. While the efficiency of proof-of-stake is desirable in blockchains that benefit from rapid confirmation, blockchains which are entirely dependent on proof-of-stake often fail to achieve the same level of network security and immutability as proof-of-work blockchains. Thus, by requiring both consensus techniques to operate in concert to approve sets of transactions, transactions may now be confirmed in a timely and scalable way, while maintaining the network security that is so alluring about blockchain databases.

While the proof-of-stake function described herein has been described with cryptographic currency coins as the accounting of wealth, other forms of stake are within the scope of the present disclosure. For example, stake could be wealth, the amount of computing resources committed to the network, contractual obligations recorded in the blockchain, or a verified identity where the identity itself is the stake. Similarly, while the proof-of-work function described herein has been described with reference to Bitcoin and the target hash cryptographic puzzles, proof-of-work may be implemented using various techniques. For example, proof-of-human-work, which require expenditure of human power and human input to solve puzzles which are not reliably solvable by computer alone.

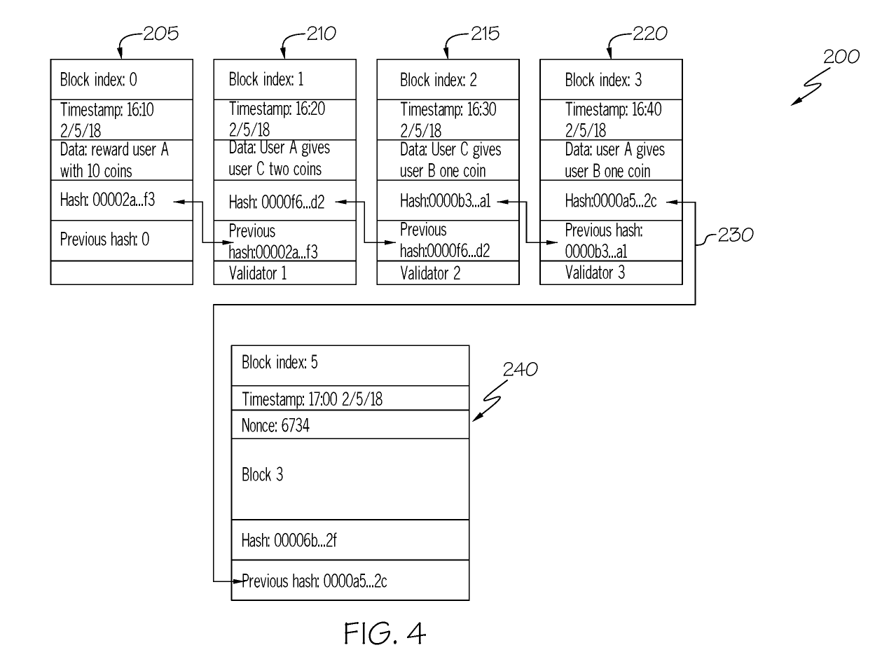

One embodiment of the method and systems described herein may involve a node or user on a blockchain network obtaining one or more proof-of-stake blocks. The node may obtain the proof-of-stake blocks by monitoring the network and identifying the blocks. As explained above, when proof-of-stake validators validate a block containing some user data, the validators may publish, transmit, or distribute the block over the blockchain network because the transactions or data within the block, i.e., the block data, is only confirmed to the blockchain once a majority of the nodes have accepted it, validated or confirmed it as a valid block, and added it to their copy of the blockchain. When a node receives one of these proof-of-stake blocks, it may confirm the validity of the block by, for example, confirming that the block was validated by a trusted and/or known validator with sufficient stake in the blockchain network. For example, FIG. 4 illustrates that each of proof-of-stake blocks 210, 215, and 220 include data associated with a respective validator. The node may access a published list of known validators to confirm the block or may interrogate a validation server. Nodes, in some embodiments, are able to identify the validator because the proof-of-stake block may be signed with the private key of the validator, and the node may be able to lookup or obtain the corresponding public key, thereby confirming that the block was in fact validated by a trusted validator, as confirmed through the private-public key pair.

In some embodiments, after confirming proof-of-stake blocks were in fact validated by a validator with sufficient stake, the node may add the proof-of-stake block to its copy of the blockchain database, thereby extending the chain. Thus, in this embodiment, data is being added to the blockchain in proof-of-stake blocks at a much higher rate than proof-of-work blocks in, for example, the Bitcoin blockchain network. While proof-of-stake blocks are being added, proof-of-work miners are working to solve complex puzzles to identify a proof-of-work. As explained above, these proof-of-work miners may be solving complex cryptographic hashing puzzles, or they may be solving human-work puzzles or other types of resource intensive puzzles. When one of the proof-of-work miners finds a valid proof-of-work or solution to the puzzle, i.e., finds a valid proof-of-work block, the node may publish or distribute it to the blockchain network similarly to how proof-of-stake validators publish proof-of-stake blocks containing user data to the network. As described above, the proof-of-work blocks within the scope of the present disclosure may be megablocks. These proof-of-work megablocks may include a representation of some of the proof-of-stake blocks added to the blockchain. For example, the proof-of-work block may include a representation of each proof-of-stake block added to the blockchain database since a prior proof-of-work block or the genesis block, depending on the circumstances and maturity of the chain. Such embodiments are illustrated by block 235 in FIG. 3 and block 255 in FIG. 6, respectively. For example, if a first proof-of-work block is added to the blockchain, followed by the addition of four proof-of-stake blocks, a second proof-of-work block may include the four proof-of-stake blocks that have not yet been represented in a proof-of-work block. This architecture provides an additional layer of security and immutability to the proof-of-stake blocks and the blockchain that does not hold up extending the chain and adding data to the chain by waiting for proof-of-work puzzles to be solved.

As described above, nodes may confirm that the proof-of-work block is valid and meets certain specified parameters before adding the proof-of-work block to the blockchain. The parameters may include things such as confirming that the solution to the proof-of-work puzzle is in fact correct. Using the blockchain target hash cryptographic puzzles as an example, confirming the proof-of-work block would include confirming that the hash of the block including the discovered salt or nonce value produces a sufficiently small hash value for a given specified round. Once a proof-of-work block is obtained from the network and the proof-of-work confirmed, nodes may add the proof-of-work block to the blockchain database, thereby securing the proof-of-stake blocks that may include the original user data.

To expand on the chaining between proof-of-stake and proof-of-work blocks, as contemplated for some embodiments, some proof-of-stake blocks include a representation, such as a hash pointer, to a prior proof-of-work block and some proof-of-stake blocks include a representation of a prior proof-of-stake block. The difference depends on the proceeding block and the posture of the chain. For example, a first proof-of-work block added to the blockchain may include a hash pointer or other representation of the proof-of-stake block that immediately precedes it on the blockchain, as is illustrated with reference to block 240 in FIG. 4. The next proof-of-stake block following the first proof-of-work block may then include a hash pointer or other representation of the first proof-of-work block, thereby directly and expressly linking the proof-of-work and proof-of-stake blocks in the same blockchain, as illustrated with reference to block 245 in FIG. 5. The next proof-of-stake block added to the blockchain may include a hash pointer or other representation of the immediately preceding block, which may be a proof-of-stake block as illustrated with reference to block 250 in FIG. 5, or could be a proof-of-work block in other embodiments. Then, the next proof-of-work block may include a hash pointer to the preceding proof-of-stake block, which itself includes a representation of the proof-of-stake block that precedes it, and so on.

In some embodiments, a proof-of-work block may include a hash pointer or other representation of the immediately preceding proof-of-stake block, or it may include a representation of each of several preceding proof-of-stake blocks up to an earlier proof-of-work block. Some techniques for representing each of the several preceding proof-of-stake blocks include, as described above, the hash value of each of the preceding proof-of-stake blocks in the preceding group, the hash value of all of the preceding group of proof-of-stake blocks, or some other representation. As illustrated in FIG. 4, for example, such other representation in block 240 may include, for example, the hash of only the preceding proof-of-stake block because that block 220 itself contains a representation of the proof-of-stake block 215 before it, and so on. Thus, each proof-of-stake block may be represented in the proof-of-work block simply by including the immediately preceding proof-of-work block, or a representation thereof.

In some embodiments, the representations of the proof-of-stake blocks in the proof-of-work block may be a representation of the whole proof-of-stake block, or may be a representation of the user data respective to the proof-of-stake block. That is, the proof-of-work block may include the user data that was previously written to the blockchain in a proof-of-stake block, or a representation thereof, such as a hash value or other identifier of that actual user data.

While it has been described for this embodiment that groups of proof-of-stake blocks alternate with proof-of-work blocks, the size or quantity of the group of proof-of-stake blocks represented in each proof-of-work block may vary. Thus, the embodiments herein are not restricted to a one-to-one proof-of-stake to proof-of-work ratio. Rather, proof-of-work blocks may represent different quantities of proof-of-stake blocks. This feature prevents holdup of the blockchain due to the complexity of proof-of-work functions.

As has been described herein, the distributed nature of blockchain databases makes it such that the integrity of the blockchain database is correlated to the number of copies of it on the network, such that there is no single holder of the true database that is vulnerable and subject to attack or manipulation. Thus, the nodes in the present architecture may provide the copies of the blockchain database, or nodes that they add to their copies of the blockchain database, to other nodes on the network. Such sharing achieves the distributed consensus discussed herein. The blockchain or newly added blocks may be provided over a network that serves the blockchain. As described above, the network may be, for example, a peer-to-peer network or a private network.

Although this example has been described from the perspective of a node, the nature of the blockchain technology is such that these processes are occurring at many nodes on the network because the blockchain is a distributed database, and thereby achieves distributed consensus and a distributed record or database. Several variations of the embodiments previously discussed will be apparent to one skilled in the art based on the foregoing discussions regarding blockchain technology, validation and confirmation mechanisms, proof-of-work and proof-of-stake functions, and the like.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
obtaining a plurality of proof-of-stake blocks, wherein each of the plurality of proof-of-stake blocks comprises respective user data to be added to a blockchain database;
confirming each of the plurality of proof-of-stake blocks;
in response to confirming each of the plurality of proof-of-stake blocks, adding each of the plurality of proof-of-stake blocks to the blockchain database;
obtaining a proof-of-work block, wherein the proof-of-work block comprises a representation of the plurality of proof-of-stake blocks added to the blockchain database;
confirming the proof-of-work block; and
in response to confirming the proof-of-work block, adding the proof-of-work block to the blockchain database.

2. The method of claim 1, wherein the proof-of-work block comprises a second proof-of-work block and the blockchain database comprises a first proof-of-work block that was previously confirmed and wherein a first proof-of-stake block of the plurality of proof-of-stake blocks comprises a representation of the first proof-of-work block and a second proof-of-stake block of the plurality of proof-of-stake blocks comprises a representation of the first proof-of-stake block.

3. The method of claim 1, wherein the proof-of-work block comprises a representation of each of the plurality of proof-of-stake blocks.

4. The method of claim 3, wherein the representation of each of the plurality of proof-of-stake blocks comprises a representation of the respective user data to be added to the blockchain database.

5. The method of claim 1, wherein the plurality of proof-of-stake blocks comprises a first plurality of proof-of-stake blocks, and further comprising:
obtaining a second plurality of proof-of-stake blocks;
confirming each of the second plurality of proof-of-stake blocks; and
in response to confirming each of the second plurality of proof-of-stake blocks, adding each of the plurality of proof-of-stake blocks to the blockchain database.

6. The method of claim 5, wherein the first plurality of proof-of-stake blocks comprises a first quantity of proof-of-stake blocks and the second plurality of proof-of-stake blocks comprises a second quantity of proof-of-stake blocks that is different from the first quantity.

7. The method of claim 6, wherein the proof-of-work block comprises a first proof-of-work block, and further comprising:
obtaining a second proof-of-work block, wherein the second proof-of-work block comprises a representation of the second plurality of proof-of-stake blocks added to the blockchain database;
confirming the second proof-of-work block; and
in response to confirming the second proof-of-work block, adding the second proof-of-work block to the blockchain database.

8. The method of claim 7, wherein the first and second proof-of-work blocks are unequal in size.

9. The method of claim 1, further comprising:
providing a representation of the blockchain database comprising the added proof-of-stake blocks and proof-of-work block to a node via a network.

10. The method of claim 1, further comprising:
obtaining consensus amongst a network comprising a plurality of nodes, wherein obtaining consensus comprises providing a representation of the blockchain database comprising the added proof-of-stake blocks and proof-of-work block to the plurality of nodes.

11. A non-transitory computer readable storage medium storing instructions that are executable to cause a system to perform operations comprising:
identifying a blockchain database, wherein the blockchain database comprises a first proof-of-work block;
obtaining a plurality of proof-of-stake blocks, wherein a first proof-of-stake block of the plurality of proof-of-stake blocks comprises a representation of the first proof-of-work block and a second proof-of-stake block of the plurality of proof-of-stake blocks comprises a representation of the first proof-of-stake block;
confirming each of the plurality of proof-of-stake blocks;
in response to confirming each of the plurality of proof-of-stake blocks, adding each of the plurality of proof-of-stake blocks to the blockchain database;
obtaining a second proof-of-work block, wherein the second proof-of-work block comprises a representation of at least one of the plurality of proof-of-stake blocks added to the blockchain database;
confirming the second proof-of-work block; and
in response to confirming the second proof-of-work block, adding the second proof-of-work block to the blockchain database.

12. The non-transitory computer readable storage medium of claim 11, wherein each of the plurality of proof-of-stake blocks comprises respective user data to be added to the blockchain database.

13. The non-transitory computer readable storage medium of claim 12, wherein the second proof-of-work block comprises a representation of each of the plurality of proof-of-stake blocks.

14. The non-transitory computer readable storage medium of claim 13, wherein the representation of each of the plurality of proof-of-stake blocks comprises a representation of the respective user data to be added to the blockchain database.

15. The non-transitory computer readable storage medium of claim 11, further comprising:
obtaining consensus amongst a network comprising a plurality of nodes, wherein obtaining consensus comprises providing a representation of the blockchain database comprising the added proof-of-stake blocks and second proof-of-work block to the plurality of nodes.

16. The non-transitory computer readable storage medium of claim 11, wherein confirming each of the plurality of proof-of-stake blocks comprises determining that each proof-of-stake block of the plurality of proof-of-stake blocks was validated by a staked validator.

17. The non-transitory computer readable storage medium of claim 11, wherein confirming the proof-of-work block comprises determining that the proof-of-work block comprises a valid solution to a proof-of-work function.

18. The non-transitory computer readable storage medium of claim 11, wherein the representation of at least one of the plurality of proof-of-stake blocks added to the blockchain database comprises each of the plurality of proof-of-stake blocks added to the blockchain database.

19. The non-transitory computer readable storage medium of claim 11, wherein confirming each of the plurality of proof-of-stake blocks comprises determining that each proof-of-stake block of the plurality of proof-of-stake blocks was validated by a staked validator.

20. A computer comprising:
a processor; and
a non-transitory computer readable storage medium storing computer readable instructions that are executed by the processor to cause the computer to perform:
identifying a blockchain database, wherein the blockchain database comprises a first proof-of-work megablock;
obtaining a plurality of proof-of-stake microblocks, wherein each of the plurality of proof-of-stake microblocks comprises respective user data and wherein a first proof-of-stake microblock of the plurality of proof-of-stake microblocks comprises a representation of the first proof-of-work megablock and a second proof-of-stake microblock of the plurality of proof-of-stake microblocks comprises a representation of the first proof-of-stake microblock;
confirming each of the plurality of proof-of-stake microblocks;
in response to confirming each of the plurality of proof-of-stake microblocks, adding each of the plurality of proof-of-stake microblocks to the blockchain database;
obtaining a second proof-of-work megablock, wherein the second proof-of-work megablock comprises the plurality of proof-of-stake microblocks added to the blockchain database;
confirming the second proof-of-work megablock; and
in response to confirming the second proof-of-work megablock, adding the second proof-of-work megablock to the blockchain database.
